(19) United States
(12) Patent Application Publication
(10) Pub. No.: US 2015/0361978 A1
(43) Pub. Date: Dec. 17, 2015

(54) OIL PUMP FOR AUTOMATIC TRANSMISSION

(71) Applicant: HYUNDAI MOTOR COMPANY, Seoul (KR)

(72) Inventors: Wonmin CHO, Hwaseong-Si (KR); Jong Su LEE, Anseong-Si (KR)

(73) Assignee: HYUNDAI MOTOR COMPANY

(21) Appl. No.: 14/546,996

(22) Filed: Nov. 18, 2014

(30) Foreign Application Priority Data
Jun. 16, 2014 (KR) 10-2014-0073079

(51) Int. Cl. F04C 11/00; F16H 41/24; F04C 15/00; F16H 57/04; F04C 2/10; F04C 2/344

(52) U.S. Cl. CPC F04C 11/001; F04C 2/10; F04C 2/344; F04C 15/008; F04C 15/0061; F04C 15/0088; F04C 15/0096; F16H 57/0436; F16H 57/0441; F16H 41/24

(57) ABSTRACT

An oil pump for an automatic transmission includes a housing provided with at least one hydraulic line formed therein. A power source is coupled to the housing and supplies a torque through a drive shaft. Two pumps are disposed respectively at both end portions of the housing and disposed concentrically with the drive shaft in the housing. The two pumps are operably connected to each other through a torque delivery shaft, and pump an oil by receiving the torque from the drive shaft. The drive shaft is inserted into and is operably connected to a first inner rotor of one pump, and is operably connected to the torque delivery shaft connected to a second inner rotor of the other pump through an engaging portion.

### CROSS-REFERENCE TO RELATED APPLICATION

This application claims the benefit of priority to Korean Patent Application No. 10-2014-0073079 filed in the Korean Intellectual Property Office on Jun. 16, 2014, the entire contents of which are incorporated herein by reference.

### TECHNICAL FIELD

The present disclosure relates to an oil pump for an automatic transmission. More particularly, the present disclosure relates to an oil pump for an automatic transmission in which two pumps driven by one electric motor is mounted in one housing.

### BACKGROUND

Vehicle manufacturers have been focusing on improving fuel economy due to increase in oil prices and exhaust gas regulations.

Improvement of fuel economy may be achieved by minimizing unnecessary power consumption of an oil pump.

A recent automatic transmission is provided with two oil pumps, a low-pressure oil pump and a high-pressure oil pump. Therefore, hydraulic pressure generated by the low-pressure oil pump is supplied to a torque converter, a cooling device, a lubrication device, and the like, and hydraulic pressure generated by the high-pressure oil pump is supplied to friction members which require high pressurized oil when shifting.

That is, general hydraulic pressure of the automatic transmission is generated by the low-pressure oil pump for the torque converter, the cooling device, the lubrication device, and the like, and hydraulic pressure for components which require high pressure such as the friction members is generated by the high-pressure oil pump.

FIG. 1 is a schematic diagram of an exemplary hydraulic pressure supply system of an automatic transmission.

Referring to FIG. 1, a hydraulic pressure supply system supplies low hydraulic pressure generated by a low-pressure oil pump 2 to a low pressure portion 4, such as a torque converter (T/C), a cooling portion, and a lubrication portion, and supplies high hydraulic pressure generated by a high-pressure oil pump 6 to a high pressure portion 8 while operating friction members provided for shifting.

That is, the low hydraulic pressure generated by the low-pressure oil pump 2 is maintained at a steady level by a low-pressure regulator valve 10 and is then supplied to the low pressure portion 4. The high-pressure oil pump 6 increases the low hydraulic pressure supplied from the low-pressure oil pump 2, and the increased hydraulic pressure by the high-pressure oil pump 6 is maintained at a steady level by a high-pressure regulator valve 12 and is then supplied to the high pressure portion 8.

However, since two oil pumps are separately operated, the operation of the hydraulic pressure supply system is complicated, and weight of the automatic transmission is high.

To improve the operation of the hydraulic pressure supply system of an automatic transmission, an oil pump for an automatic transmission where the low-pressure oil pump 2 and the high-pressure oil pump 6 are simultaneously driven by one power source has been developed to minimize a length of the automatic transmission and reduce the weight and cost by optimizing power delivery between the low-pressure oil pump 2 and the high-pressure oil pump 6.

The above information disclosed in this Background section is only for enhancement of understanding of the background of the invention, and therefore, it may contain information that does not form the prior art that is already known in this country to a person of ordinary skill in the art.

### SUMMARY

The present disclosure has been made in an effort to provide an oil pump for an automatic transmission having one electric motor in a housing driving two oil pumps for minimizing length, weight, and cost thereof by reducing the number of components therein.

An oil pump for an automatic transmission according to an exemplary embodiment of the present inventive concept may include a housing provided with at least one hydraulic line formed therein. A power source is coupled to the housing and supplies a torque through a drive shaft. Two pumps are disposed respectively at both end portions of the housing and disposed concentrically with the drive shaft in the housing. The two pumps are operably connected to each other through a torque delivery shaft, and pump oil by receiving the torque from the drive shaft. The drive shaft is inserted into and is operably connected to a first inner rotor of one pump, and is operably connected to the torque delivery shaft connected to a second inner rotor of the other pump through an engaging portion.

The other oil pump may be a low pressure oil pump for receiving the oil in an oil tank through the at least one hydraulic line, generating a low pressure using the oil, and discharging the generated low pressure. The one oil pump may be a high pressure oil pump for receiving a portion of the low pressure discharged from the low-pressure oil pump, generating a high pressure using the portion of the low pressure, and discharging the generated high pressure.

The at least one hydraulic line may include an input line for supplying the oil in the oil tank to the low-pressure oil pump. A low-pressure discharge line supplies the oil discharged from the low-pressure oil pump to a low pressure portion. A bifurcating line is bifurcated from the low-pressure discharge line to supply a portion of the oil in the low-pressure discharge line to the high-pressure oil pump. A high-pressure discharge line supplies the oil discharged from the high-pressure oil pump to a high pressure portion.

The power source may be an electric motor.

Each of the two pumps may be a vane pump.

Each of the two pumps may be a gear pump.

A boss portion having a cylindrical shape may be integrally formed with the first inner portion of the inner rotor of the one pump and may rotatably support the drive shaft on a connecting hole formed in the housing.

The engaging portion may include an engaging hole formed at an end of the torque delivery shaft operably connected to the second inner rotor of the other pump. An engaging protrusion is operably inserted into the engaging hole and formed at an end of the drive shaft.

The engaging hole and the engaging protrusion may be splined or may be coupled through a key or may have a polygonal shape for a power delivery.

An oil pump for an automatic transmission according to another exemplary embodiment of the present inventive concept may include a housing provided with at least one hydraulic line formed therein. An electric motor is coupled to the housing and supplies a torque through a drive shaft. A low-pressure oil pump is disposed at one end portion of the housing and disposed concentrically with the drive shaft in the housing. The low-pressure oil pump generates and discharges a low pressure by receiving oil in an oil tank through the at least one hydraulic line. A high-pressure oil pump is disposed at another end portion of the housing and disposed concentrically with the drive shaft in the housing. The high-pressure oil pump includes a first inner rotor connected to the drive shaft, and generates and discharges a high pressure by receiving a portion of oil discharged from the low-pressure oil pump. A torque delivery shaft in a connecting hole is formed in the housing. One end of the torque delivery shaft is operably connected to an end portion of the drive shaft through an engaging portion, and another end thereof is operably connected to the low-pressure oil pump. A boss portion rotatably supports the drive shaft in the connecting hole and is formed at an inner portion of the first inner rotor of the high-pressure oil pump.

The at least one hydraulic line may include an input line for supplying the oil in the oil tank to the low-pressure oil pump. A low-pressure discharge line supplies the oil discharged from the low-pressure oil pump to a low pressure portion. A bifurcating line is bifurcated from the low-pressure discharge line to supply a portion of the oil in the low-pressure discharge line to the high-pressure oil pump. A high-pressure discharge line supplies the oil discharged from the high-pressure oil pump to a high pressure portion.

Each of the low-pressure oil pump and the high-pressure oil pump may be a vane pump.

Each of the low-pressure oil pump and the high-pressure oil pump may be a gear pump.

The engaging portion may include an engaging hole formed at an end of the torque delivery shaft operably connected to a second inner rotor of the low-pressure oil pump. An engaging protrusion is operably inserted into the engaging hole and formed at an end of the drive shaft.

The engaging hole and the engaging protrusion may be splined or may be coupled through a key or have a polygonal shape for power delivery.

### BRIEF DESCRIPTION OF THE DRAWINGS

FIG. 1 is a schematic diagram of an exemplary hydraulic pressure supply system of an automatic transmission.

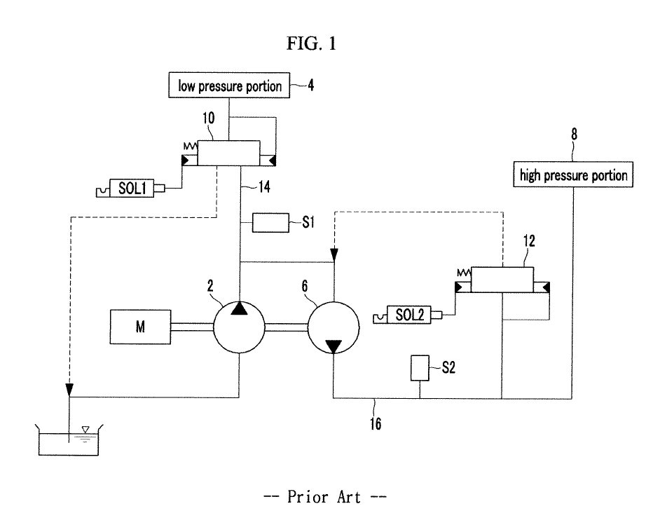

FIG. 2 is a cross-sectional view of an oil pump for an automatic transmission according to an exemplary embodiment of the present inventive concept.

FIG. 3 is a perspective view illustrating components used in the oil pump for an automatic transmission according to an exemplary embodiment of the present inventive concept.

### DETAILED DESCRIPTION

An exemplary embodiment of the present inventive concept will hereinafter be described in detail with reference to the accompanying drawings.

Description of components that are not necessary for explaining the exemplary embodiment will be omitted.

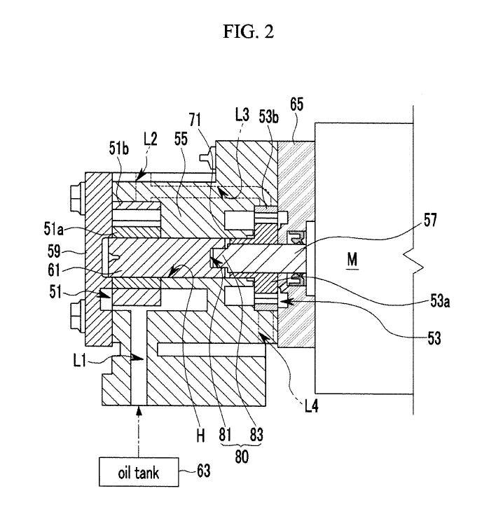

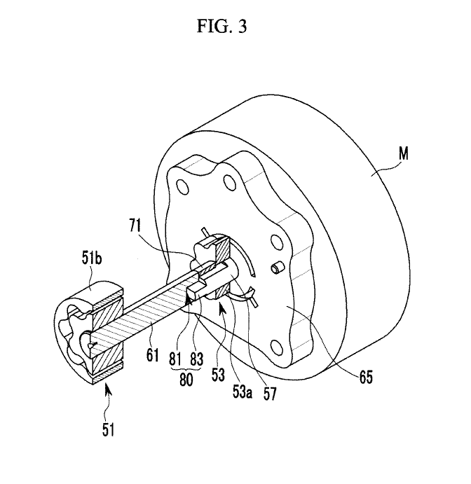

FIG. 2 is a cross-sectional view of an oil pump for an automatic transmission according to an exemplary embodiment of the present inventive concept, and FIG. 3 is a perspective view illustrating components used in the oil pump for an automatic transmission according to an exemplary embodiment of the present inventive concept.

Referring to FIG. 2, an oil pump 50 for an automatic transmission according to an exemplary embodiment of the present inventive concept includes a low-pressure oil pump 51 and a high-pressure oil pump 53 mounted in one housing 55. Low hydraulic pressure generated by the low-pressure oil pump 51 is supplied to a low pressure portion such as a torque converter (T/C), a cooling portion, and a lubrication portion, and high hydraulic pressure generated by the high-pressure oil pump 53 is supplied to a high pressure portion for operation friction members related to shifting.

The low hydraulic pressure is a lower pressure facilitating operation of the torque converter (T/C) and cooling and lubrication, and the high hydraulic pressure is a high pressure facilitating operation of a plurality of friction members.

Referring to FIG. 2, the low-pressure oil pump 51 and the high-pressure oil pump 53 are operably connected through a torque delivery shaft 61 and are driven by an electric motor M that is a power source in the oil pump 50 for an automatic transmission according to the exemplary embodiment of the present inventive concept. The electric motor M may be controlled by a transmission control unit (not shown).

Hereinafter, the oil pump 50 for an automatic transmission according to the exemplary embodiment of the present inventive concept will be described in further detail.

Referring to FIG. 2, the oil pump 50 for an automatic transmission according to the exemplary embodiment of the present inventive concept includes the housing 55, the electric motor M, the low-pressure oil pump 51, the high-pressure oil pump 53, the torque delivery shaft 61, and an engaging portion 80.

The housing 55 is formed by a single body, and is provided with at least one hydraulic line formed therein and a connecting hole H formed horizontally at a center portion in the housing.

The electric motor M is the power source and is assembled with the housing 55. The electric motor M provides torque through a drive shaft 57.

It is illustrated in the exemplary embodiment of the present inventive concept that the power source is the drive motor M, but the power source is not limited to the drive motor M. The power source may be a hub receiving torque in a torque converter of an automatic transmission.

The low-pressure oil pump 51 is disposed in an end portion of the housing 55 concentrically with the drive shaft 57 and is enclosed by the housing 55 and a front cover 59 assembled to the housing 55. The low-pressure oil pump 51 receives an oil in an oil tank 63 through an input line L1, generates hydraulic pressure for operating the torque converter (T/C), cooling and lubrication, and discharges the generated hydraulic pressure through a low-pressure discharge line L2.

The high-pressure oil pump 53 is disposed in the other end portion of the housing 55 concentrically with the drive shaft 57 and is enclosed by the housing 55 and a rear cover 65 assembled to the housing 55. An inner rotor 53a of the high-pressure oil pump 53 is connected to the drive shaft 57. The high-pressure oil pump 53 receives the oil discharged from the low-pressure oil pump 51 through a bifurcating line L3, generates relatively high hydraulic pressure for operating a plurality of friction members related to shifting, and discharges the high hydraulic pressure through a high-pressure discharge line L4.

The at least one hydraulic line includes the input line L1, the low-pressure discharge line L2, the bifurcating line L3, and the high-pressure discharge line L4.

The input line L1 is formed in the housing 55 and is adapted to supply the oil in the oil tank 63 to the low-pressure oil pump 51.

The low-pressure discharge line L2 is formed in the housing 55 and is for supplying the oil discharged from the low-pressure oil pump 51 to the low pressure portion of the automatic transmission.

In addition, the bifurcating line L3 is formed in the housing 55 and is for supplying a portion of the oil in the low-pressure discharge line L2 to the high-pressure oil pump 53. The bifurcating line L3 is bifurcated from the low-pressure discharge line L2 and is connected to the high-pressure oil pump 53.

The high-pressure discharge line L4 is formed in the housing 55 and delivers the oil discharged from the high-pressure oil pump 53 to the high pressure portion of the automatic transmission.

It is exemplified in exemplary embodiment of the present invention but is not limited that each of the low-pressure oil pump 51 and the high-pressure oil pump 53 is a gear pump. Each of the low-pressure oil pump 51 and the high-pressure oil pump 53 may be a vane pump. In this case, a plurality of vanes may be mounted at the inner rotors 51a and 53a of the low-pressure oil pump 51 and the high-pressure oil pump 53.

Referring to FIG. 3, the torque delivery shaft 61 is mounted in the connecting hole H formed in the housing 55, and is provide with an end portion connected to the inner rotor 51a of the low-pressure oil pump 51 and the other end portion where the engaging portion 80 is formed so as to be connected to and receive torque from the drive shaft 57 of the electric motor M.

Herein, the engaging portion 80 includes an engaging hole 81 and an engaging protrusion 83 such that the other end portion of the torque delivery shaft 61 connected to the inner rotor 51a of the low-pressure oil pump 51 and the drive shaft 57 of the electric motor M connected to the inner rotor 53a of the high-pressure oil pump 53 are operably connected to each other.

The engaging hole 81 is a polygonal hole formed at an interior circumference of the other end portion of the torque delivery shaft 61 connected to the inner rotor 51a of the low-pressure oil pump 51, and the engaging protrusion 83 is a polygonal end portion having the same shape as the engaging hole 81. The engaging protrusion 83 is formed at the end portion of the drive shaft 57 and is inserted into the engaging hole 81 so as to deliver torque in a rotating direction.

It is illustrated in the exemplary embodiment of the present inventive concept but is not limited that the engaging hole 81 and the engaging protrusion 83 have a polygonal shape for power delivery. For example, the engaging hole 81 and the engaging protrusion 83 may be coupled to each other through a spline or a key.

In addition, the drive shaft 57 is inserted into a center portion of the inner rotor 53a of the high-pressure oil pump 53. A boss portion 71 is formed at an inner portion of the inner rotor 53a of the high-pressure oil pump 53.

That is, the boss portion 71 having a cylindrical shape is integrally formed with the inner portion of the inner rotor 53a of the high-pressure oil pump 53 and is operably connected to the drive shaft 57 together with the inner rotor 53a. An exterior circumference of the boss portion 71 is rotatably supported by the connecting hole H formed in the housing 55 so as to rotatably support the drive shaft 57.

As shown in FIG. 3, it is illustrated in the exemplary embodiment of the present inventive concept but is not limited that the drive shaft 57 is coupled to the inner rotor 53a of the high-pressure oil pump 53 and the boss portion 71 through a polygonal shape. The drive shaft 57 may be coupled to the inner rotor 53a of the high-pressure oil pump 53 and the boss portion 71 through a spline or a key.

In the oil pump for an automatic transmission 50 according to the exemplary embodiment of the present inventive concept, the inner rotors 51a and 53a of the low-pressure oil pump 51 and the high-pressure oil pump 53 are connected by the torque delivery shaft 61 and the drive shaft 57, and are driven by one electric motor M.

In addition, if a rotational speed of the electric motor M is controlled, hydraulic pressure and oil amount supplied to the low pressure portion and the high pressure portion can be optimized.

In addition, since the low-pressure oil pump 51 and the high-pressure oil pump 53 driven by one electric motor M are disposed in one housing 55, and the inner rotor 53a of the high-pressure oil pump 53 and the boss portion 71 are integrally formed with each other in the exemplary embodiment of the present inventive concept, the drive shaft 57 is rotatably supported by the boss portion 71, and the torque delivery shaft 61 connected to the inner rotor 51a of the low-pressure oil pump 51 and the drive shaft 57 are operably connected through the engaging portion 80. Therefore, additional components for supporting shafts are not necessary.

Since the number of components can be reduced, a length, weight, and cost of the oil pump may be minimized.

In addition, since the inner rotors 51a and 53a are disposed in the center of the housing 55 when the low-pressure oil pump 51 and the high-pressure oil pump 53 are gear pumps, eccentricity between the inner rotors 51a and 53a and the outer rotors 51b and 53b and shaft misalignment may be prevented.

While this disclosure has been described in connection with what is presently considered to be practical exemplary embodiments, it is to be understood that the invention is not limited to the disclosed embodiments, but on the contrary, is intended to cover various modifications and equivalent arrangements included within the spirit and scope of the appended claims.

What is claimed is:

1. An oil pump for an automatic transmission comprising:
a housing provided with at least one hydraulic line formed therein;
a power source coupled to the housing, the power source supplying a torque through a drive shaft; and
two pumps disposed respectively at both end portions of the housing and disposed concentrically in the housing with the drive shaft and operably connected to each other through a torque delivery shaft,
wherein the drive shaft is inserted into and is operably connected to a first inner rotor of one pump and is operably connected to the torque delivery shaft connected to a second inner rotor of the other pump through an engaging portion, and
the two pumps pump an oil by receiving the torque from the drive shaft.

2. The oil pump of claim 1, wherein
the other oil pump of the two oil pumps is a low-pressure oil pump for receiving the oil from an oil tank through the at least one hydraulic line, generating a low pressure using the oil, and discharging the generated low pressure, and
the one oil pump of the two oil pumps is a high-pressure oil pump for receiving a portion of the low pressure discharged from the low-pressure oil pump, generating a high pressure using the portion of the low pressure, and discharging the generated high pressure.

3. The oil pump of claim 2, wherein the at least one hydraulic line comprises:
an input line for supplying the oil in the oil tank to the low-pressure oil pump;
a low-pressure discharge line for supplying the oil discharged from the low-pressure oil pump to a low pressure portion;
a bifurcating line bifurcated from the low-pressure discharge line to supply a portion of the oil in the low-pressure discharge line to the high-pressure oil pump; and
a high-pressure discharge line for supplying the oil discharged from the high-pressure oil pump to a high pressure portion.

4. The oil pump of claim 1, wherein the power source is an electric motor.

5. The oil pump of claim 1, wherein each of the two pumps is a vane pump.

6. The oil pump of claim 1, wherein each of the two pumps is a gear pump.

7. The oil pump of claim 1, wherein a boss portion having a cylindrical shape is integrally formed with an inner portion of the first inner rotor of the one pump and rotatably supports the drive shaft on a connecting hole formed in the housing.

8. The oil pump of claim 1, wherein the engaging portion comprises:
an engaging hole formed at an end of the torque delivery shaft operably connected to the second inner rotor of the other pump; and
an engaging protrusion operably inserted into the engaging hole and formed at an end of the drive shaft.

9. The oil pump of claim 8, wherein the engaging hole and the engaging protrusion are splined or are coupled through a key or have a polygonal shape for a power delivery.

10. The oil pump of claim 1, wherein the housing comprises a front cover mounted on a front side of the housing and covering the low-pressure oil pump, and a rear cover mounted to the power source and covering the high-pressure oil pump.

11. The oil pump of claim 7, wherein the connecting hole is formed horizontally at a center of the housing.

12. The oil pump of claim 7, wherein the low pressure portion includes a torque converter (T/C), a cooling portion, and a lubrication portion, and the high pressure portion includes friction members for gear shifting.

13. The oil pump of claim 1, wherein the power source is a hub for receiving torque in a torque converter of the automatic transmission.

14. An oil pump for an automatic transmission comprising:
a housing provided with at least one hydraulic line formed therein;
an electric motor coupled to the housing and supplying a torque through a drive shaft;
a low-pressure oil pump disposed at one end portion of the housing and disposed concentrically in the housing with the drive shaft, the low-pressure oil pump generating and discharging a low pressure by receiving an oil from an oil tank through the at least one hydraulic line;
a high-pressure oil pump disposed at another end portion of the housing and disposed concentrically in the housing with the drive shaft, the high-pressure oil pump including a first inner rotor connected to the drive shaft and generating and discharging a high pressure by receiving a portion of oil discharged from the low-pressure oil pump;
a torque delivery shaft in a connecting hole formed in the housing, one end of the torque delivery shaft operably connected to an end portion of the drive shaft through an engaging portion, and another end thereof operably connected to the low-pressure oil pump; and
a boss portion rotatably supporting the drive shaft in the connecting hole and formed at an inner portion of the first inner rotor of the high-pressure oil pump.

15. The oil pump of claim 14, wherein the at least one hydraulic line comprises:
an input line for supplying the oil in the oil tank to the low-pressure oil pump;
a low-pressure discharge line for supplying the oil discharged from the low-pressure oil pump to a low pressure portion;
a bifurcating line bifurcated from the low-pressure discharge line to supply a portion of the oil in the low-pressure discharge line to the high-pressure oil pump; and
a high-pressure discharge line for supplying the oil discharged from the high-pressure oil pump to a high pressure portion.

16. The oil pump of claim 14, wherein each of the low-pressure oil pump and the high-pressure oil pump is a vane pump.

17. The oil pump of claim 14, wherein each of the low-pressure oil pump and the high-pressure oil pump is a gear pump.

18. The oil pump of claim 14, wherein the engaging portion comprises:
an engaging hole formed at an end of the torque delivery shaft operably connected to a second inner rotor of the low-pressure oil pump; and
an engaging protrusion operably inserted into the engaging hole and formed at an end of the drive shaft.

19. The oil pump of claim 18, wherein the engaging hole and the engaging protrusion are splined or are coupled through a key or have a polygonal shape for a power delivery.
